(19) United States
(12) Patent Application Publication
(10) Pub. No.: US 2026/0209026 A1
(43) Pub. Date: Jul. 23, 2026

(54) TANK OVERFILL AND PUMP RUNAWAY PREVENTION FOR A FLUID MANAGEMENT SYSTEM

(71) Applicant: Graco Minnesota Inc., Minneapolis, MN (US)

(72) Inventors: Mark L. Bauck, Coon Rapids, MN (US); Gregory D. Sieckert, Plymouth, MN (US); Glenn E. Highland, East Bethel, MN (US); Jacob K. Krech, Andover, MN (US); Cory J. Haskamp, Isanti, MN (US); Bradley G. Kahler, Otsego, MN (US)

(21) Appl. No.: 19/157,883

(22) PCT Filed: Feb. 16, 2024
(86) PCT No.: PCT/US2024/016179

§ 371 Date: Aug. 19, 2025

Related U.S. Application Data
(60) Provisional application No. 63/447,201, filed on Feb. 21, 2023.

(51) Int. Cl. B67D 7/32; B67D 7/04

(52) U.S. Cl. CPC B67D 7/3209; B67D 7/04; B67D 7/3272

(57) ABSTRACT

A level manager (16) is configured to manage fluid levels in multiple portions of a lubricant distribution system (10). The level manager (16) is connectable to multiple lubricant level sensors (44, 46) and flow controls (42) on a single channel. The level manager (16) is operable in various states and substates to control actions taken by the level manger (16) in response to the inputs from the level sensors (44, 46).

### CROSS-REFERENCE TO RELATED APPLICATION(S)

This application claims priority to U.S. Provisional Application No. 63/447,201 filed Feb. 21, 2023 and entitled “TANK OVERFILL AND PUMP RUNAWAY PREVENTION FOR A FLUID MANAGEMENT SYSTEM,” the disclosure of which is hereby incorporated by reference in its entirety.

### BACKGROUND

The present disclosure generally relates to fluid management systems. More particularly, this disclosure relates to tank overfill and pump runaway prevention for fluid management systems.

Fluid management has become increasingly important to control the costs of fluid overhead. For example, many vehicle fleet managers and auto dealerships have installed fluid management systems to efficiently dispense liquid lubricants, such as motor oil or transmission fluid. Such fluid management systems frequently include a fluid tank and pump located away from the dispensing point. Fluid management systems can include wireless transmission and reception of meter and tank level information to simplify tracking of fluid dispenses throughout an entire facility.

The fluid dispensing system can include bulk tanks that hold supplies of fresh fluid. The bulk tanks dispense fluid to dispensing meters for application. The bulk tanks are refilled by suppliers that typically connect a supply of lubricant to a fill pipe at a location outside of the building. The resupply lubricant is pumped into the bulk tank to refill the bulk tank. Operators need to know when the bulk tank is approaching empty so the supplier can be contacted to provide additional lubricant. Operators also need know when the bulk tank is approaching full during refill so the supply can be shut off. The fluid dispensing system can further include waste tanks that store supplies of waste fluid (e.g., oil drained from a vehicle). Operators collect the waste fluid in smaller mobile tanks and then dump the waste fluid in the large waste tanks that collect the bulk of the waste fluid. A waste operator is contacted to empty the waste tanks when the waste tanks approach a full level.

### SUMMARY

According to an aspect of the disclosure, a level manager for a lubricant distribution system includes a housing; a plurality of channel ports mounted to the housing, each channel port providing a connection point for data and power communications with the level manager; control circuitry; and memory encoded with instructions that, when executed by the control circuitry, cause the control circuitry to: generate a control signal in response to a control level signal from a control level sensor and provide the control signal to a flow control, the flow control configured to stop flow of lubricant one of into a lubricant tank and out of the lubricant tank based on the control signal; and generate an alarm signal in response to one of the control level signal and a monitor level signal from a monitor level sensor and provide the alarm signal to a tank alarm to activate the tank alarm. The control level sensor is one of a high level sensor of the lubricant tank and a low level sensor of the lubricant tank, and the monitor level sensor is the other one of the high level sensor and the low level sensor. The control level sensor, the monitor level sensor, the flow control, and the tank alarm are connected to the level manager via a signal channel connected to a single channel port of the plurality of channel ports.

According to an additional or alternative aspect of the disclosure, a fluid management system includes a level manager and a system controller. The level manager is configured to generate a tank status signal and send the tank status signal to the system controller, the system controller configured to generate and send an electronic communication outside of the lubricant distribution system based on the tank status signal.

According to another additional or alternative aspect of the disclosure, a level manager for use in a lubricant distribution system includes a housing; a plurality of channel ports mounted to the housing, each channel port providing a connection point for a channel to connect with the level manager; a plurality of control switches, each control switch operably associated with a single channel of the plurality of channels; control circuitry; and memory encoded with instructions that, when executed by the control circuitry, cause the control circuitry to: generate a control signal in response to a control level signal from a control level sensor and provide the control signal to a flow control, the flow control configured to stop flow of lubricant one of into a lubricant tank and out of the lubricant tank based on the control signal; and generate an alarm signal in response to one of the control level signal and a monitor level signal from a monitor level sensor and provide the alarm signal to a tank alarm to activate the tank alarm. Each control switch is actuatable between a plurality of positions that are each associated with different operational states of the level manager for the single channel, the operational states including: a first substate in which the level manager is configured to generate the alarm signal based on the control signal; and a second substate in which the level manager is configured to generate the alarm signal based on the monitor signal.

According to yet another additional or alternative aspect of the disclosure, a lubricant distribution system includes a bulk tank configured to store a supply of fresh lubricant; a pump configured to pump the fresh lubricant from the bulk tank to an application system; a flow control configured to disable pumping by the pump based on receipt of a flow control signal; a tank alarm configured to output a visual alarm, an audio alarm, or both based on receipt of an alarm signal; a low level sensor configured to generate a control level signal based on fall of lubricant within the bulk tank; a high level sensor configured to generate a monitor level signal based on rise of lubricant within the bulk tank; and a level manager configured to: generate the flow control signal in response to the control level signal from the low level sensor; and generate the alarm signal in response to one of the control level signal and the monitor level signal. The level manager is operable in a first substate in which the level manager generates the alarm signal based on the control level signal and in a second substate in which the level manager generates the alarm signal based on the monitor level signal.

According to yet another additional or alternative aspect of the disclosure, a lubricant distribution system includes a bulk tank configured to store a supply of fresh lubricant; a fill valve actuatable between a closed state, in which the fill valve blocks fresh lubricant flow into the bulk tank, and an open state, in which the fresh lubricant can flow to the bulk tank; a flow control configured to close the fill valve based on receipt of a flow control signal; a tank alarm configured to output a visual alarm, an audio alarm, or both based on receipt of an alarm signal; a low level sensor configured to generate a monitor level signal based on fall of lubricant within the bulk tank; a high level sensor configured to generate a control level signal based on rise of lubricant within the bulk tank; and a level manager configured to: generate the flow control signal in response to the control level signal from the high level sensor; and generate the alarm signal in response to one of the control level signal and the monitor level signal. The level manager is operable in a first substate in which the level manager generates the alarm signal based on the control level signal and in a second substate in which the level manager generates the alarm signal based on the monitor level signal.

According to yet another additional or alternative aspect of the disclosure, a lubricant distribution system includes a waste tank configured to store a supply waste lubricant; a pump configured to pump the waste lubricant from a collection vessel to the waste tank; a flow control configured to disable pumping by the pump based on receipt of a flow control signal; a tank alarm configured to output a visual alarm, an audio alarm, or both based on receipt of an alarm signal; a high level sensor configured to generate a waste level signal based on rise of lubricant within the waste tank; and a level manager configured to: generate the flow control signal in response to the waste level signal from the high level sensor; and generate the alarm signal in response to one of the waste level signal. The high level sensor, the flow control, and the tank alarm are connected to the level manager via a signal channel connected to a single channel port of the level manager.

### BRIEF DESCRIPTION OF THE DRAWINGS

FIG. 1 is a schematic diagram of a lubricant distribution system.

FIG. 2A is an isometric view of a level manager.

FIG. 2B is an elevational view of the level manager 16 with a door opened to show an interior of the level manager.

FIG. 2C is an enlarged view of detail C in FIG. 2B showing a control switch.

FIG. 3 is a diagram illustrating operating states of the level manager relative to positions of control switch.

FIG. 4 is a schematic diagram showing a level manager connected to a waste system.

FIG. 5 is a schematic diagram showing a level manager connected to a supply system.

FIG. 6 is a schematic diagram showing a level manager connected to a supply system.

FIG. 7 is a schematic diagram showing an alternative level manager connected to a supply system.

### DETAILED DESCRIPTION

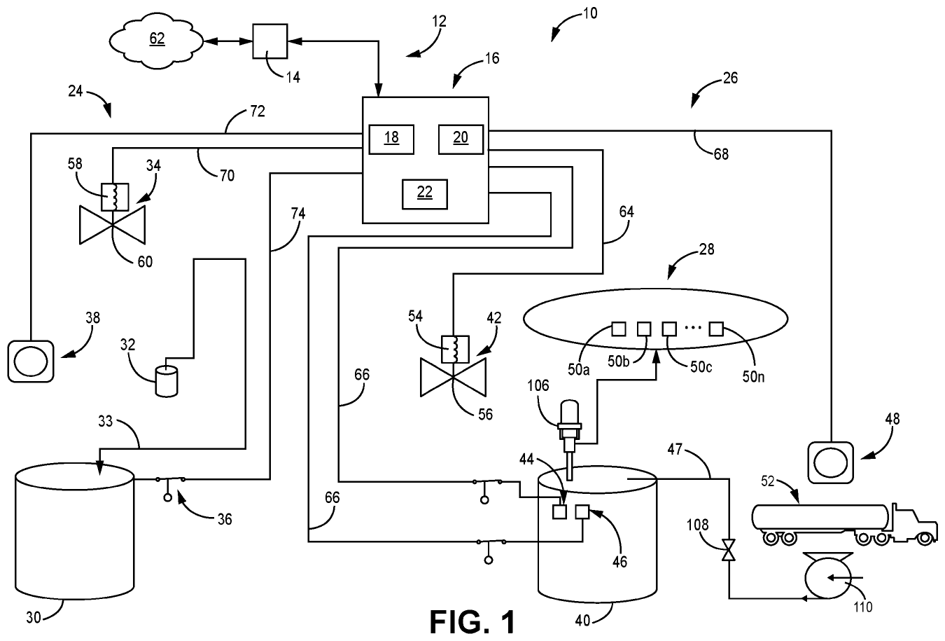

FIG. 1 is a schematic diagram of distribution system 10. Distribution system 10 includes fluid management system 12 having system controller 14 and level manager 16, waste system 24, supply system 26, and application system 28. Waste system 24, supply system 26, and application system 28 form the fluid handling portions of distribution system 10. Waste system 24 includes waste tank 30, collection vessel 32, waste line 33, waste flow control 34, waste level sensor 36, and waste tank alarm 38. Supply system 26 includes bulk tank 40, supply flow control 42, supply line 43, control level sensor 44, monitor level sensor 46, fill line 47, and supply tank alarm 48. Application system 28 includes fluid dispensers 50a-50n.

Distribution system 10 is configured to handle, output, and receive a fluid. For example, distribution system 10 can be a lubrication system configured to handle lubricant. While lubricant (e.g., motor oil, transmission fluid, gear oil, grease, etc.) is used herein as an exemplar, it is understood that distribution system 10 can be utilized to dispense any desired type of fluid. Distribution system 10 is configured to store supplies of fresh lubricant for use in distribution system 10, to output lubricant at desired application points, and to collect and store waste lubricant.

The supply system 26 stores the supplies of fresh lubricant for use in distribution system 10 and provides the lubricant to application system 28 for outputting from distribution system 10. The application system 28 outputs the lubricant from distribution system 10. In the example shown, fluid dispensers 50a-50n provide the discrete application points for the lubricant within application system 28. Fluid dispensers 50a-50n can include one or more manual lubricant dispensers configured to be manually handled and activated to dispense lubricant, such as a lubricant dispenser as disclosed in U.S. Pat. No. 11,078,069 to Graco Minnesota, Inc., the disclosure of which is hereby incorporated by reference in its entirety. The waste system 24 is configured to collect and store the waste lubricant. Waste system 24 can be similar to the waste system disclosed in U.S. Pat. No. 11,099,587 to Graco Minnesota, Inc., the disclosure of which is hereby incorporated by reference in its entirety.

Fluid management system 12 is configured to manage the lubricant within a fluid distribution system 10, such as a vehicle dealership, a body shop, a fleet management center, etc. Fluid management system 12 can be configured to generate data regarding the status of the fluid in the system (e.g., fluid type, fluid volume, fluid age, etc.), regarding dispenses of the fluids (e.g., identity of user making a dispense, volume dispensed, type of fluid dispensed, time and duration of dispense event, etc.), among other options. System controller 14 is communicatively coupled to other components of the fluid management system 12. System controller 14 is configured as a system-wide controller that can accumulate data from other components and can provide instructions and commands to other components. In some examples, system controller 14 can be configured to generate and send data outside of fluid management system 12, such as over network 62, to communicate with vendors, such as for pick up of waste lubricant or provision of fresh supply lubricant. Network 62 can be configured as a local area network (LAN), wide area network (WAN), cellular network, and/or the Internet, among other options. System controller 14 can be configured as a system controller as disclosed in U.S. Pat. No. 11,292,710 to Graco Minnesota, Inc., the disclosure of which is hereby incorporated by reference in its entirety, among other options.

Level manager 16 is configured to monitor the levels of fluids in waste system 24 and/or supply system 26. Level manager 16 can generate and send command signals to control flow into and/or out of the lubricant reservoirs of waste system 24 and/or supply system 26. Level manager 16 can be configured to initiate action based on the lubricant in waste tank 30 reaching a waste level threshold. Level manager 16 can be configured to initiate action based on the lubricant in bulk tank 40 reaching an upper level threshold and/or reaching a lower level threshold.

Level manager 16 is further configured to generate and output information regarding the status of the fluid levels in waste system 24 and/or supply system 26. Level manager 16 can be configured to generate outputs regarding fluid levels within waste system 24 and/or supply system 26. Level manager 16 can be configured to generate outputs regarding the fill status of the reservoirs of waste system 24 and supply system 26 (e.g., that a reservoir is full, approaching full, empty, and/or approaching empty).

Level manager 16 can be operatively connected, communicatively and/or electrically, with system controller 14. Level manager 16 can be configured to communicate with system controller 14 over network 62, among other options. Level manager 16 can be communicatively connected to system controller 14 by a wired or wireless communication link. It is understood, however, that not all examples of fluid management system 12 include system controller 14. In some examples, with or without system controller 14, level manager 16 can be configured to provide outputs via alarms (e.g., waste tank alarm 38 and/or supply tank alarm 48) and/or user interface 22. For example, level manager 16 can cause visual and/or audio outputs by waste tank alarm 38 and user interface 22 to provide information to a user regarding the fill status of waste tank 30 of waste system 24. For example, level manager 16 can cause visual and/or audio outputs by supply tank alarm 48 and/or user interface 22 to provide information to a user regarding the fill status of bulk tank 40 of supply system 26.

Level manager 16 is configured to store software, implement functionality, and/or process instructions. Level manager 16 is configured to perform any of the functions discussed herein, including receiving an output from any sensor referenced herein, detecting any condition or event referenced herein, and controlling operation of any components referenced herein. Level manager 16 can be of any suitable configuration for controlling operation of components of distribution system 10 (e.g., waste flow control 34, waste tank alarm 38, supply flow control 42, supply tank alarm 48), receiving signals from components of fluid management system 12 (e.g., waste level sensor 36, control level sensor 44, monitor level sensor 46), gathering data, processing data, etc. Level manager 16 can include hardware, firmware, and/or stored software. Level manager 16 can be entirely or partially mounted on one or more circuit boards. Level manager 16 can be of any type suitable for operating in accordance with the techniques described herein.

Control circuitry 18, in one example, is configured to implement functionality and/or process instructions. For example, control circuitry 18 can be capable of processing instructions stored in memory 20. Examples of control circuitry 18 can include one or more of a processor, a microprocessor, a controller, a digital signal processor (DSP), an application specific integrated circuit (ASIC), a field-programmable gate array (FPGA), or other equivalent discrete or integrated logic circuitry. Control circuitry 18 can be entirely or partially mounted on one or more circuit boards.

Memory 20 can be configured to store information before, during, and/or after operation. Memory 20, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 20 is a temporary memory, meaning that a primary purpose of memory 20 is not long-term storage. Memory 20, in some examples, is described as volatile memory, meaning that memory 20 does not maintain stored contents when power to level manager 16 is turned off. Examples of volatile memories can include random access memories (RAM), dynamic random access memories (DRAM), static random access memories (SRAM), and other forms of volatile memories. In some examples, memory 20 is used to store program instructions for execution by control circuitry 18. Memory 20, in one example, is used by software or applications to temporarily store information during program execution.

Memory 20, in some examples, also includes one or more computer-readable storage media. Memory 20 can be configured to store larger amounts of information than volatile memory. Memory 20 can further be configured for long-term storage of information. In some examples, memory 20 includes non-volatile storage elements. Examples of such non-volatile storage elements can include magnetic hard discs, optical discs, flash memories, or forms of electrically programmable memories (EPROM) or electrically erasable and programmable (EEPROM) memories.

User interface 22, such as a keyboard, touchscreen, monitor, mouse, smartphone, tablet, dial, knob, switch, light, audio output, combinations thereof, or other suitable interface device, allows a user to interact with level manager 16, such as by retrieving information from memory 20, receiving notifications, initiating the software stored in memory 20, inputting additional information to memory 20, setting an operational state of level manager 16, among other options. User interface 22 can be integrated into level manager 16 or can be a device separate from level manager 16. User interface 22 can be configured to receive inputs from the user and/or can be configured to provide outputs to the user.

Level manager 16 is configured to operatively interface with one or more lubricant handling systems and is configured to monitor levels of lubricant within the lubricant handling systems. The lubricant handling system can be configured as the waste system 24 that handles waste lubricant generated by the lubricant distribution system 10. The lubricant handling system can be configured as the supply system 26 that provides fresh lubricant for use within the lubricant distribution system 10. In the example shown, level manager 16 is configured to operatively connect to each lubricant handling system by one or more channels, as discussed in more detail below.

Supply system 26 is configured to store supplies of fresh lubricant for application by fluid dispensers 50a-50n. Bulk tank 40 is configured to store a large volume of fresh lubricant. Bulk tank 40 is a high-volume container capable of storing large quantities of fresh lubricant for application by one or multiple of fluid dispensers 50a-50n. Bulk tank 40 has a defined internal volume for receiving and storing the fresh lubricant. In some examples, bulk tank 40 has a capacity of up to 500 gallons, 1,000 gallons, 2,000 gallons, or more. Bulk tank 40 stores the fresh lubricant for dispensing by application system 28. The volume of lubricant in bulk tank 40 drops as lubricant is dispensed and bulk tank 40 is refilled by a lubricant supplier, which can be an off-site hauler that delivers the fresh lubricant to distribution system 10. Distribution pump 106, which can include one or more individual pumps, is configured to draw lubricant from bulk tank 40 and pump the lubricant downstream to application system 28.

Supply vessel 52 is configured to provide fresh lubricant to refill bulk tank 40. Supply vessel 52 can be configured as a tanker truck that transports the fresh lubricant to supply system 26. Supply vessel 52 is typically operated by the lubricant supplier and is not a component of distribution system 10. The supply vessel 52 can have a volume of 1,000 gallons; 3,000 gallons; or up to 11,600 gallons. The supply vessel 52 can have a volume greater than bulk tank 40 such that less than the full volume of fresh lubricant in supply vessel 52 is transferred to bulk tank 40 to fully refill bulk tank 40. During refill operations of bulk tank 40, the fresh lubricant is pumped from supply vessel 52 to bulk tank 40 by fill pump 110 through fill line 47. Fill pump 110 can be of any suitable configuration for pumping the fresh lubricant. For example, fill pump 110 can be a hydraulically powered, a power take-off pump, among other options.

Control level sensor 44 and monitor level sensor 46 are configured as level sensors that generate data regarding the level of the fresh lubricant in bulk tank 40. One of control level sensor 44 and monitor level sensor 46 is configured as a high level sensor and the other of control level sensor 44 and monitor level sensor 46 is configured as a low level sensor. Control level sensor 44 and monitor level sensor 46 can be of any type suitable for generating data regarding the lubricant level within the bulk tank 40. For example, one or both of control level sensor 44 and monitor level sensor 46 can include a ball float configured to actuate a switch to an open state based on the ball shifting to a threshold position with the changing fresh lubricant level.

In the example shown, control level sensor 44 provides input for level manager 16 to control the supply flow control 42. For example, the supply flow control 42 can be an air solenoid control valve that is actuated to a closed state to stop flow of compressed air and thus stop flow of the fresh lubricant to or from bulk tank 40. Either the high level or the low level sensor may be configured as the control level sensor 44. The high level sensor being configured as the control level sensor 44 controls to prevent tank overfill and the low level sensor being configured as the control level sensor 44 controls to prevent pump runaway which can occur when trying to pump from a dry bulk tank 40.

Monitor level sensor 46 provides secondary monitoring on the same tank, if needed. In some examples, multiple channels can be used, if needed, to control remote bulk fill stop and control low fluid level pump runaway (e.g., by actively controlling both powering of the supply pump (for pump runaway prevention) and powering of the fill valve (for bulk tank overfill protection)) on a single tank.

The high level sensor is configured to trigger on the rise of the fresh lubricant as the bulk tank 40 is being filled. The high level sensor is configured to generate and send a high level signal based on the high level sensor sensing the level of the fresh lubricant in the bulk tank 40 reaching an upper level threshold. The high level sensor can be of any type suitable for sensing the rising fluid level within the bulk tank 40. The high level sensor can include a ball float configured to actuate a switch to an open state based on the ball rising to contact the switch with the rising fresh lubricant level.

The high level sensor (configured as one of the control level sensor 44 and monitor level sensor 46) is operatively connected, communicatively and/or electrically, to level manager 16 to provide the high level signal to the level manager 16. The high level signal indicates to level manager 16 that the fresh lubricant level has reached the upper level threshold. The fresh lubricant level reaching the upper level threshold can indicate that the bulk tank 40 is full and should not receive additional lubricant from supply vessel 52.

The low level sensor is configured to trigger on the fall of the fresh lubricant as the bulk tank 40 is being emptied as lubricant is output to application system 28. The low level sensor is configured to generate and send a low level signal based on the low level sensor sensing the level of the fresh lubricant in the bulk tank 40 reaching a lower level threshold. The low level sensor can be of any type suitable for sensing the falling fluid level within the bulk tank 40. For example, the low level sensor can include a ball float configured to actuate a switch to an open state based on the ball falling to contact the switch with the falling fresh lubricant level.

The low level sensor (configured as the other one of the control level sensor 44 and monitor level sensor 46) is operatively connected, communicatively and/or electrically, to level manager 16 to provide the low level signal to the level manager 16. The low level signal indicates to level manager 16 that the fresh lubricant level has reached the lower level threshold. The fresh lubricant level reaching the lower level threshold indicates that the bulk tank 40 requires refilling. The lower threshold level can be when bulk tank 40 is empty or can be when bulk tank 40 has some additional volume for dispense.

Supply flow control 42 is configured to control flow of the fresh lubricant into or out of the bulk tank 40. In the example shown, supply flow control 42 is configured as a solenoid-powered valve. A solenoid 54 of supply flow control 42 can be actuated to shut off flow of the lubricant to or from the bulk tank 40. The supply flow control 42 can be configured to shut off supply of driving power (e.g., compressed air in pneumatic examples) to a flow control component (e.g., a supply pump or fill valve) that controls flow of lubricant to or from bulk tank. The solenoid 54 of supply flow control 42 can be configured to actuate control valve 56 to a closed state to shut off the flow of compressed air, thereby depowering the supply pump or closing the fill valve.

The flow control component can be a supply pump mounted to draw lubricant from bulk tank 40 (e.g., distribution pump 106) and drive the lubricant to application system 28. The supply pump can be mounted to the bulk tank 40. In such an example, the level manager 16 is configured to cause the supply flow control 42 to shut off driving power to the supply pump to prevent the supply pump from drawing additional lubricant from bulk tank 40. For example, the supply flow control 42 can shut off a supply of compressed air to the supply pump to depower the supply pump.

The flow control component can be a fill valve 108 mounted on the line 47 through which fresh lubricant is transferred between supply vessel 52 and bulk tank 40 to refill bulk tank 40. In some examples, the level manager 16 is configured to cause the supply flow control 42 to cause the fill valve 108 to actuate to a closed state. For example, the supply flow control 42 can shut off a supply of compressed air to the fill valve 108 to cause the fill valve 108 to return to a normally closed state.

Supply flow control 42 is operatively connected, communicatively and/or electrically, with level manager 16 to receive command signals from level manager 16. For example, supply flow control 42 and level manager 16 can be connected by a wired connection. In the example shown, supply flow control 42 is operatively connected to level manager 16 by supply control line 64. Supply control line 64 can be formed as a wired connection. Supply control line 64 can, in some examples, be formed as a wireless connection. In the example shown, supply control line 64 is a wired connection between level manager 16 and supply flow control 42. Supply control line 64 can be configured to provide power to the coils of solenoid 54.

Level manager 16 is configured to generate and send a supply control signal to supply flow control 42. The supply control signal causes supply flow control 42 to actuate to an off state to stop flow of the fresh lubricant. For example, the supply control signal can be provision of or removal of an electrical signal provided to solenoid 54 to cause the control valve 56 to close. In some examples, the supply flow control 42 can be configured as normally open such that solenoid 54 is powered to close control valve 56. In some examples, the supply flow control 42 can be configured as normally closed such that solenoid 54 is powered to open control valve 56 and solenoid 54 is depowered to cause control valve 56 to close. In such an example, removal of the power from solenoid 54 can be considered to form the supply control signal. With control valve 56 closed, the flow of compressed air to the flow control component (e.g., distribution pump 106 or fill valve 108) is shut off and the flow control component stops flow of the fresh lubricant.

Level manager 16 is configured to generate and send an alarm signal to supply tank alarm 48 to activate supply tank alarm 48. Supply tank alarm 48 can be configured to generate any desired alarm that can provide an indication of the sensed fluid level to the user. Supply tank alarm 48 can be configured to generate a visual alarm. Supply tank alarm 48 can be configured as a light that illuminates in response to the alarm signal received from level manager 16. For example, supply tank alarm 48 can be a panel mounted light that indicates the alarm status at a location remote from level manager 16. Supply tank alarm 48 can additionally or alternatively include an audio alarm configured to generate an audible output.

Supply tank alarm 48 is operatively connected to level manager 16 by alarm line 68. Alarm line 68 can be formed as a wired or wireless connection. In the example shown, alarm line 68 is formed as a wired connection between supply tank alarm 48 and level manager 16. Alarm line 68 can be configured to provide electrical power to supply tank alarm 48 to activate supply tank alarm 48. Level manager 16 can control provision of the electrical power to supply tank alarm 48. Providing electrical power to activate supply tank alarm 48 can be considered to be provision of the alarm signal. Supply tank alarm 48 is mounted remote from level manager 16. Supply tank alarm 48 is formed separate from level manager 16 and operatively connected to level manager 16 only by alarm line 68 in the example shown.

Level manager 16 is configured to generate a bulk empty signal based on the level manager 16 receiving the low level signal. In examples including system controller 14, level manager 16 can be configured to send the bulk empty signal to the system controller 14. The system controller 14 can generate and send a communication outside of fluid management system 12 through network 62, such as to the fresh lubricant supplier to schedule delivery of fresh lubricant to bulk tank 40 based on the level manager 16 receiving the bulk empty signal. For example, the system controller 14 can generate and send an electronic communication (e.g., email) to the fresh lubricant supplier in response to the bulk tank empty signal. The electronic communication can schedule delivery of additional fresh lubricant via a supply vessel 52.

Level manager 16 can be configured to generate a bulk full signal based on the level manager 16 receiving the high level signal. In examples including system controller 14, level manager 16 can be configured to send the bulk full signal to system controller 14. The system controller 14 can record that the volume of lubricant in bulk tank 40 is full and track the lubricant based on the bulk tank 40 beginning in the full state. The system controller 14 can generate and send a communication outside of fluid management system 12 through network 62, such as to the fresh lubricant supplier to acknowledge delivery of fresh lubricant to bulk tank 40. For example, the system controller 14 can generate and send an electronic communication (e.g., email) to the fresh lubricant supplier in response to the bulk full signal from level manager 16.

The control level sensor 44 is associated with controlling flow of fresh lubricant to or from bulk tank 40. Level manager 16 is configured to generate and send the supply control signal to supply flow control 42 based on a control level signal received from the control level sensor 44. Supply system 26 can be configured in multiple states based on which level sensor (high level sensor or low level sensor) is configured as the control level sensor 44. In some examples, the level manager 16 is configured in an outflow state in which level manager 16 controls flow of lubricant out of bulk tank 40. The level manager 16 can additionally or alternatively be configured in an inflow state in which level manager 16 controls flow of lubricant into bulk tank 40.

Control level sensor 44 and monitor level sensor 46 are operatively connected to level manager 16 by sensor lines 66. Each sensor line 66 can be formed as a wired or wireless connection. In the example shown, sensor lines 66 are formed as wired connections between control level sensor 44 and level manager 16 and between monitor level sensor 46 and level manager 16. Control level sensor 44 and monitor level sensor 46 are configured to provide the control level signal and the monitor level signal to level manager 16 via sensor lines 66. For example, the sensor line 66 can be a normally closed circuit and opening a contact in the circuit can be considered to be generation of the level signal. For example, the ball float shifting with the changing lubricant level can cause the contact to open. Control level sensor 44 and monitor level sensor 46 are mounted remote from level manager 16. Control level sensor 44 and monitor level sensor 46 are formed separate from level manager 16 and disposed remote from level manager 16. In some examples, control level sensor 44 and monitor level sensor 46 can be operatively connected to level manager 16 only by sensor lines 66.

Supply system 26 can be in an outflow configuration in which level manager 16 shuts off flow of lubricant out of the bulk tank 40. With level manager 16 in the outflow state, flow out of the bulk tank 40 is automatically shut off by level manager 16. In such an example, the low level sensor forms the control level sensor 44 such that the control signal is generated and sent based on the fall of the fresh lubricant within bulk tank 40. Automatically actuating the flow control component (formed by the supply pump (e.g., displacement pump 106) in the low level control level sensor 44 example) to stop flow prevents the pump from running away, which in a pump runaway state the lubricant pump continues to run and attempt to pump while in a dry state. Stopping operation of the supply pump based on the low level signal can prevent damage to the supply pump that can occur when supply pump runs away in a dry state.

The level manager 16 can generate an output based on the control signal received from the control level sensor 44. For example, level manager 16 can generate and emit an alarm via user interface 22 to indicate that the low level threshold has been reached. For example, one or more lights of level manager 16 can be illuminated and/or an audible alarm can be emitted from level manager 16, among other alarm options.

In the outflow state, the high level sensor forms the monitor level sensor 46. The monitor level sensor 46 is communicatively connected to the fluid monitor to provide a monitor signal based on the rise of the fresh lubricant within bulk tank 40. The monitor signal indicates to the level manager 16 that the fresh lubricant level has reached the high level threshold in such an example. The level manager 16 can generate an output based on the monitor signal received from the monitor level sensor 46. For example, level manager 16 can generate and emit an alarm via user interface 22 to indicate that the high level threshold has been reached. For example, one or more lights of level manager 16 can be illuminated and/or an audible alarm can be emitted from level manager 16, among other alarm options.

The level manager 16 can generate and provide the alarm signal to the supply tank alarm 48 based on inputs received from one of the control level sensor 44 and the monitor level sensor 46. In some examples, supply tank alarm 48 can be disposed on an exterior of a facility, such as mounted on an exterior side of an exterior wall, to provide indications to the operator of the supply vessel 52. The level manager 16 can be further configured to operate in a full alarm state and an empty alarm state. The full alarm state can be considered to form a first outflow substate of the outflow state. The empty alarm state can be considered to form a second outflow substate of the outflow state.

With level manager 16 configured in the first outflow substate, level manager 16 is configured to generate and send the alarm signal based on the monitor signal received from monitor level sensor 46. Supply system 26 can be configured such that supply tank alarm 48 is disposed proximate the location where supply vessel 52 is fluidly connected to bulk tank 40. Supply tank alarm 48 can be disposed to be visible to the operator operating a fill pump configured to pump the lubricant from supply vessel 52 to bulk tank 40. For example, supply tank alarm 48 can be mounted on an exterior wall proximate the location where the supply vessel 52 fluidly connects to bulk tank 40. Alarm line 68 can extend from the exterior of the facility where supply tank alarm 48 is located to the interior of the facility where level manager 16 is located. Activation of supply tank alarm 48 indicates to a user that the upper lubricant level threshold has been reached during filling of bulk tank 40 such that the user can shut off the pump filling bulk tank 40. Supply tank alarm 48 is meant to be positioned at a location that is most likely to alert a user that the fresh lubricant level has reached the upper lubricant level threshold such that flow of fresh lubricant to bulk tank 40 should be stopped.

With level manager 16 configured in the second outflow substate, level manager 16 is configured to generate and send the alarm signal to supply tank alarm 48 based on the control signal received from control level sensor 44. Supply system 26 can be configured such that supply tank alarm 48 is disposed proximate the bulk tank 40, proximate the pump control of bulk tank 40, proximate the fluid dispensers 50a-50n of application system 28, among other location options. Supply tank alarm 48 is meant to be positioned at a location that is most likely to alert a user that the fresh lubricant level has reached the lower level threshold such that bulk tank 40 should be refilled and operation of the supply pump pumping the lubricant from the bulk tank 40 should be stopped. For example, supply tank alarm 48 can be mounted on an interior wall proximate the location of bulk tank 40 or at a location in application system 28 where the fresh lubricant is being dispensed (e.g., at fluid dispensers 50a-50n), among other location options. Activation of supply tank alarm 48 indicates to a user that the lower level threshold has been reached during emptying of bulk tank 40.

In the first outflow substate, the level manager 16 actively controls flow out of bulk tank 40 based on the control signal and generates and sends the alarm signal to supply tank alarm 48 based on the monitor signal. Level manager 16 controls lubricant flow out of bulk tank 40 based on the fall of the fresh lubricant level. Level manager 16 receives the low level signal from control level sensor 44. The level manager 16 does not actively control flow based on the monitor signal but does generate the alarm signal based on the monitor signal. The level manager 16 thereby remotely alerts regarding the lubricant level based on the rise of the rise of the fresh lubricant level. Level manager 16 can be configured to generate and send the bulk empty signal to the system controller 14 based on the control signal and can be configured to generate and send the bulk tank full signal to the system controller 14 based on the monitor signal, in examples including system controller 14. Level manager 16 can further output alarm indicators via user interface 22 (e.g., visual and/or audio signals) based on one or both of the control signal and the monitor signal while operating in the first outflow substate.

In the second outflow substate, the level manager 16 actively controls flow out of bulk tank 40 based on the control signal and generates and sends the alarm signal to supply tank alarm 48 based on the control signal. Level manager 16 controls lubricant flow out of bulk tank 40 and generates the alarm signal based on the fall of the fresh lubricant level. Level manager 16 receives the high level signal from monitor level sensor 46 but does not actively control flow based on the monitor signal and does not generate an alarm signal based on the monitor signal. Level manager 16 can be configured to generate and send the bulk empty signal to the system controller 14 based on the control signal and can be configured to generate and send the bulk full signal to the system controller 14 based on the monitor signal, in examples including system controller 14. Level manager 16 can further output alarm indicators via user interface 22 (e.g., visual and/or audio signals) based on one or both of the control signal and the monitor signal while operating in the second outflow substate.

Level manager 16 can be in an inflow state such that level manager 16 can shut off flow of lubricant into bulk tank 40. In the inflow state, flow into the bulk tank 40 is automatically shut off by level manager 16. In such an example, the high level sensor forms the control level sensor 44 such that the control signal is generated and sent based on the rise of the fresh lubricant within bulk tank 40. Automatic actuating the flow control component (formed by the fill valve 108 in the high level control level sensor 44 example) to stop flow prevents lubricant from overfilling bulk tank 40, which can lead to spillage, waste, damage, and undesirable downtime.

The level manager 16 generates and provides the alarm signal to the supply tank alarm 48 based on inputs received from one of the control level sensor 44 and the monitor level sensor 46 with the level manager 16 in the inflow state. The level manager 16 can be configured to operate in the full alarm configuration and the empty alarm configuration while operating in the inflow state. The full alarm configuration can be considered to form a first inflow substate of the inflow state. The empty alarm configuration can be considered to form a second inflow substate of the inflow state.

With level manager 16 in the first inflow substate, level manager 16 is configured to generate and send the alarm signal to the supply tank alarm 48 based on the rise of the fresh lubricant level. The level manager 16 generates and sends the alarm signal based on the control signal received from control level sensor 44. With level manager 16 in the second inflow substate, level manager 16 is configured to generate and send the alarm signal to the supply tank alarm 48 based on the fall of the fresh lubricant level. The level manager 16 generates and sends the alarm signal based on the monitor signal received from monitor level sensor 46.

In the first inflow substate, the level manager 16 actively controls flow into bulk tank 40 based on the control signal and generates and sends the alarm signal based on the control signal. Level manager 16 controls lubricant flow into bulk tank 40 and generates the alarm signal based on the rise of the fresh lubricant level. Level manager 16 receives the low level signal from monitor level sensor 46 but does not actively control flow based on the monitor signal and does not generate an alarm signal to supply tank alarm 48 based on the monitor signal. Level manager 16 can be configured to generate and send the bulk empty signal to the system controller 14 based on the monitor signal and can be configured to generate and send the bulk full signal to the system controller 14 based on the control signal, in examples including system controller 14. Level manager 16 can further output alarm indicators via user interface 22 (e.g., visual and/or audio signals) based on one or both of the control signal and the monitor signal while operating in the first inflow substate.

In the second inflow substate, the level manager 16 actively controls flow into bulk tank 40 based on the control signal and generates and sends the alarm signal based on the monitor signal. Level manager 16 controls lubricant flow into bulk tank 40 based on the rise of the fresh lubricant level. Level manager 16 generates the alarm signal based on the fall of the fresh lubricant level. Level manager 16 receives the low level signal from monitor level sensor 46. The level manager 16 does not actively control flow based on the monitor signal but does generate the alarm signal based on the monitor signal. Level manager 16 can be configured to generate and send the bulk empty signal to the system controller 14 based on the monitor signal and can be configured to generate and send the bulk tank signal to the system controller 14 based on the control signal, in examples including system controller 14. Level manager 16 can further output alarm indicators via user interface 22 (e.g., visual and/or audio signals) based on one or both of the control signal and the monitor signal while operating in the second inflow substate.

Waste system 24 is configured to accumulate and store supplies of waste lubricant. Waste tank 30 is a high-volume container capable of storing large quantities of waste lubricant from multiple collection vessels 32. Waste tank 30 has a defined internal volume for receiving the waste lubricant. In some examples, waste tank 30 has a capacity of up to 500 gallons or more. Waste tank 30 stores the waste oil until an off-site hauler can retrieve the waste lubricant from waste tank 30 and transport the waste lubricant to a disposal facility.

Waste tank 30 is configured to receive and store a large volume of waste lubricant. Collection vessel 32 is configured to receive a relatively smaller volume of waste lubricant and transfer that waste lubricant to waste tank 30, such as via waste line 33. Collection vessel 32 is the vessel that stores volumes of waste lubricant as it is removed (e.g., during changing of motor oil for a vehicle) during operation of distribution system 10. Collection vessel 32 can be portable to be moved about the facility and to then transfer captured waste lubricant to waste tank 30 for storage before off-site disposal. Collection vessel 32 can be any suitable vessel for collecting the waste lubricant. Collection vessel 32 typically has a capacity of 25-50 gallons, but it is understood that collection vessel 32 can be of any desired volume. Collection vessel 32 can be moved to any desired location within the facility to receive the waste lubricant. When collection vessel 32 requires emptying, collection vessel 32 is transferred to a location where collection vessel 32 can be fluidly connected to waste tank 30, such as to a pump configured to pump the waste lubricant from the collection vessel 32 to the waste tank 30 via waste line 33.

Waste level sensor 36 is configured as a level sensor that generates data regarding the level of the waste lubricant in bulk tank 40. Waste level sensor 36 is configured as a high level sensor in the example shown. Waste level sensor 36 can be of any type suitable for sensing the lubricant level within the waste tank 30. For example, waste level sensor 36 can include a ball float configured to actuate a switch to an open state based on the ball shifting with the changing waste lubricant level.

The waste level sensor 36 is configured to generate and send a waste level signal based on the waste level sensor 36 sensing the level of the waste lubricant in the waste tank 30 reaching a waste level threshold. In the example shown, the waste level sensor 36 is configured as a high level sensor configured to trigger on the rise of the waste lubricant as the waste tank 30 is being filled. The waste level sensor 36 is operatively connected, communicatively and/or electrically, to level manager 16 to provide the waste level signal to the level manager 16. The waste level signal indicates to level manager 16 that the waste lubricant level has reached the upper waste level threshold. The waste lubricant level reaching the waste level threshold can indicate that the waste tank 30 is full and requires emptying. In examples including system controller 14, level manager 16 can be configured to generate and send a waste full signal to the system controller 14. The system controller 14 can generate and send a communication outside of fluid management system 12, such as through network 62, to the waste lubricant collector to schedule emptying of the waste tank 30. For example, the system controller 14 can generate and send an electronic communication (e.g., email) to the waste lubricant collector in response to the waste full signal. The electronic communication can schedule collection of the waste lubricant.

Waste level sensor 36 is operatively connected to level manager 16 by waste sensor line 74. Waste sensor line 74 can be formed as a wired or wireless connection. In the example shown, waste sensor line 74 is formed as wired connections between waste level sensor 36 and level manager 16. Waste level sensor 36 is configured to provide the waste level signal to level manager 16 via waste sensor line 74. For example, the waste sensor line 74 can be a normally closed circuit and opening a contact in the circuit can be considered to be generation of the waste level signal. For example, the ball float shifting with the changing lubricant level can cause the contact to open. Waste level sensor 36 is mounted remote from level manager 16. Waste level sensor 36 is formed separate from level manager 16 and can be operatively connected to level manager 16 only by waste sensor line 74.

Waste flow control 34 is configured to control flow of waste lubricant into waste tank 30. For example, waste flow control 34 can be configured to control provision of driving power to a waste pump configured to pump waste lubricant from a collection vessel 32 to waste tank 30. For example, the waste flow control 34 can be configured to stop flow of driving air that powers the waste pump in examples in which the waste pump is pneumatically powered. In the example shown, waste flow control 34 is configured as a solenoid-powered valve. A waste solenoid 58 of waste flow control 34 can be actuated to shut off flow of the lubricant to the waste tank 30. The waste flow control 34 can be configured to shut off supply of compressed air to a flow control component (e.g., a waste pump or a valve on waste line 33) that controls flow of lubricant to waste tank 30. The waste pump is configured to pump lubricant from collection vessel 32 to waste tank 30. The waste solenoid 58 of waste flow control 34 can be configured to actuate waste control valve 56 to a closed state to shut off the flow of compressed air, thereby depowering the waste pump.

Waste flow control 34 can be operatively connected, communicatively and/or electrically, with level manager 16 to receive command signals from level manager 16. For example, waste flow control 34 and level manager 16 can be connected by a wired connection. In the example shown, waste flow control 34 is operatively connected to level manager 16 by waste control line 70. Waste control line 70 can be formed as a wired connection. Waste control line 70 can, in some examples, be formed as a wireless connection. In the example shown, waste control line 70 is a wired connection between level manager 16 and waste flow control 34. Waste control line 70 can be configured to provide power to the coils of waste solenoid 58.

Level manager 16 is configured to generate and send a waste control signal to waste flow control 34 based on the level manager 16 receiving the waste level signal from waste level sensor 36. The waste control signal causes waste flow control 34 to actuate to an off state to stop flow of waste lubricant to waste tank 30. For example, the waste control signal can be provision of or removal of an electrical signal provided to waste solenoid 58 to cause waste control valve 60 to close. In some examples, the waste flow control 34 can be configured as normally open such that waste solenoid 58 is powered to close waste control valve 60. In some examples, the waste flow control 34 can be configured as normally closed such that waste solenoid 58 is powered to open waste control valve 60 and waste solenoid 58 is depowered to cause waste control valve 60 to close. With the waste control valve 60 closed, the flow of compressed air to the waste pump is shut off and the waste pump is depowered.

Level manager 16 can be configured to generate and send a waste alarm signal to waste tank alarm 38 to activate waste tank alarm 38. Level manager 16 is configured to generate and send the waste alarm signal based on the level manager 16 receiving the waste level signal from waste level sensor 36. The level manager 16 sends the waste alarm signal to waste tank alarm 38. Waste tank alarm 38 is similar to supply tank alarm 48 and can be configured to generate any desired alarm output that can provide an indication that waste tank 30 is full to the user.

Waste tank alarm 38 can be configured as a light emitter that illuminates in response to the alarm signal received from level manager 16. For example, waste tank alarm 38 can be a panel mounted light that indicates the alarm status remotely from level manager 16. Waste tank alarm 38 can additionally or alternatively include an audio alarm configured to generate an audible output. Waste tank alarm 38 is operatively connected to level manager 16 by waste alarm line 72. Waste alarm line 72 can be formed as a wired or wireless connection. In the example shown, waste alarm line 72 is formed as a wired connection between waste tank alarm 38 and level manager 16. Waste alarm line 72 can be configured to provide electrical power to waste tank alarm 38 to activate waste tank alarm 38. Level manager 16 can control provision of the electrical power to waste tank alarm 38. Waste tank alarm 38 is mounted remote from level manager 16. Waste tank alarm 38 is formed separate from level manager 16 and operatively connected to level manager 16 only by waste alarm line 72.

Level manager 16 can be configured to generate a waste full signal based on the level manager 16 receiving the waste level signal from waste level sensor 36. In examples including system controller 14, level manager 16 can be configured to send the waste full signal to the system controller 14. The system controller 14 can generate and send a communication outside of fluid management system 12, such as through network 62, to the waste lubricant collector to schedule collection of waste lubricant from waste tank 30. For example, the system controller 14 can generate and send an electronic communication (e.g., email) to the waste lubricant collector in response to the waste full signal. The electronic communication can schedule emptying of waste lubricant from waste tank 30.

In the example shown, the various lines shown for communicatively connecting level manager 16 with supply system 26 are connected to level manager 16 as a single channel. In the example shown, the various lines shown for communicatively connecting level manager 16 with waste system 24 are connected to level manager 16 as a single channel. It is understood that fluid management system 12 can include additional waste systems 24 and/or supply systems 26 connected to level manager 16. Each additional system can be connected via one or more additional channels.

Each channel is an independent circuit that monitors separate tanks and/or controls separate control valves (e.g., air control solenoid valve). In the example shown, each channel has an input/output connection for a control valve (e.g., an air control solenoid valve among other options), a remote alarm (e.g., audio and/or visual), and one or more level sensors (e.g., a control level sensor 44 and a monitor level sensor 46, or a waste level sensor 36). The equipment is grouped into a single channel to provide the desired functionality. The grouping into a single channel allows for simplified assembly of system and for a more compact level manager 16. The grouping into a single channel for control of a whole system (e.g., a waste system 24 or a supply system 26 controlled on that single channel) facilitates simplified operation of fluid management system 12 and provides for easier communication to ensure continuous operation without costly downtime associated with waiting for filling of bulk tank 40 or emptying of waste tank 30.

In the example shown, waste system 24 is configured as a single sensor system in which a single level sensor (waste level sensor 36) is communicatively connected to level manager 16. The single level sensor causes actuation of waste flow control 34 to stop lubricant flow and causes generation of an alarm signal to activate waste tank alarm 38.

In the example shown, supply system 26 is configured as a dual sensor system in which multiple level sensors (a high level sensor and a low level sensor) are communicatively connected to level manager 16 and are associated with a single bulk tank 40. The level sensors are configured as either the control level sensor 44 or the monitor level sensor 46. Level manager 16 is configured to actively control flow of the lubricant based on the outputs from the control level sensor 44. Level manager 16 is configured to control flow of the lubricant based on either the output from the high level sensor or the output from the low level sensor, depending on an operating state of the level manager 16. Level manager 16 is configured to generate and output the alarm signal based on either the output from the control level sensor 44 or the output from the monitor level sensor 46, depending on an operating state of the level manager 16. In some examples, level manager 16 can be configurable between substates (e.g., between first and second outflow substates or between first and second inflow substates) for generating the alarm signal. For example, the level manager 16 can be actuated between the substates via user interface 22, such as by manipulation of a switch.

In some examples, the wiring connection between the level sensors and the level manager 16 designates the level sensors as either the control level sensor 44 or the monitor level sensor 46. One of the high level sensor and the low level sensor is designated as the control level sensor 44 and the other of the high level sensor and the low level sensor becomes the monitor level sensor 46 based on which sensor is connected as the control level sensor 44 and which sensor is connected as the high level sensor 46.

In some examples, the level sensors are configured by the wired connections with level manager 16. For example, the two level sensors, supply flow control 42, and tank alarm 48 can be wired to a single connector (such as a single M12 connector, among other options). Each wire can be connected at a designated point, which connection points are associated with component designations stored in the memory 20 of level manager 16. For example, the various connection points in the electrical connector can be coded to indicate to the user at set up which connection points should be used for which components. The level sensor desired to operate as the control level sensor 44 is connected to the connection points that are coded as the control sensor connections. The level sensor desired to operate as the monitor level sensor 46 is connected to connection points that are coded as the monitor sensor connections. The supply flow control 42 can be connected to connection points that are coded as control connections. The tank alarm 48 can be connected to connection points that are coded as alarm connections. For example, the connection points can be color coded such that each of the connection points, eight connection points in the example discussed with two points for each connection, is indicated by a different color.

Fluid management system 12 can be configured as a closed system in which a signal is sent based on contacts opening. The level sensor float shifting to open a sensor contact causes generation of the level signal by the level sensor. In the example shown, each wired connection of the channel is independent of the other wire connections. If damage occurs to the communication link between level manager 16 and one of the other components, the other wired links remain operational. For example, if the wire connection to tank alarm 48 is broken, level manager 16 can continue to receive signals from control level sensor 44 and monitor level sensor 46 and can continue to control flow via supply flow control 42. In some examples, level manager 16 can output an alarm via user interface 22 that a connection is opened. In examples not including a tank alarm, the connection points for tank alarm 48 can be placed in a closed state.

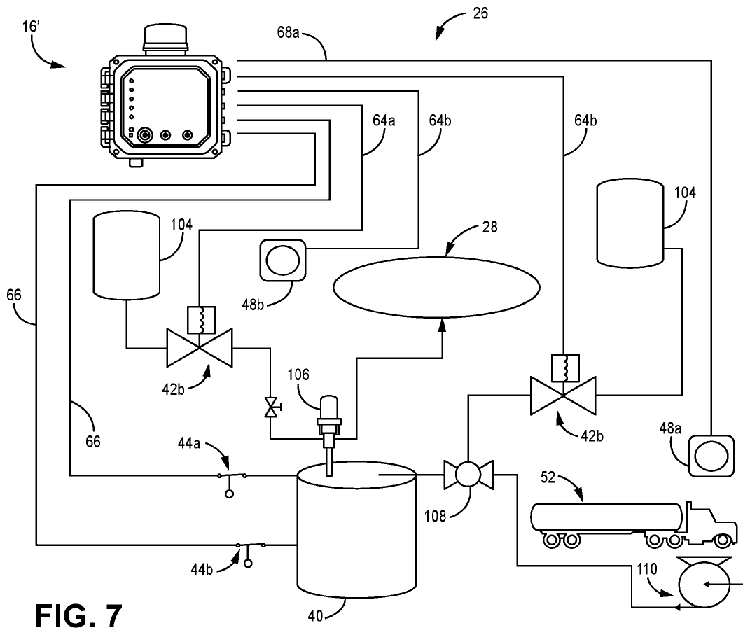

Each channel in the example discussed includes up to four discrete connections between level manager 16 and a component grouping. Up to four separate components are operably connected to level manager 16 on the single channel. While the example shown includes eight connection points (two for each wired connection) in the single connector for connecting to up to four components, it is understood that not all examples are so limited. Some examples of level manager 16 can be configured to connect to a single connector including up to twelve connection points that support controlling operation of up to six components, as shown in the example shown in FIG. 7. In such an example, each level sensor can form a control level sensor 44 configured to control both operation of a flow control component to stop flow into or out of bulk tank 40 and generation of the alarm signal. Level manager 16 can be configured to generate and send an alarm signal to one of tank alarms 48 based on the high level signal and can send an alarm signal to the other one of tank alarms 48 based on the low level signal. The six components can be the supply pump 106, the fill valve 108, the control level sensor 44, the monitor level sensor 46, and the two tank alarms 48.

Each channel of the level manager 16 is individually configurable to set an operating state of the level manager 16 for that channel. Each channel can be configured to a different state from the other channels or to the same state as the other channels. Level manager 16 is configured to control operation and generate signals for each channel individually. Level manager 16 can operate multiple channels simultaneously. For example, level manager 16 can simultaneously operate components of both waste system 24 and supply system 26 via separate channels.

The user interface 22 of level manager 16 can include one or more switches that are actuatable by the user to configure the level manager 16. The level manager 16 can be put in various operational states (e.g., the first inflow substate, the second inflow substate, the first outflow substate, the second outflow substate) based on the statuses of the one or more switches. Level manager 16 is configured to placed in a desired operating state at set up of fluid management system 12.

An example of configuring level manager 16 for a supply system 26 in the first outflow substate is discussed in more detail. In such an example, level manager 16 is desired to be operatively connected to the supply flow control 42 associated with the supply pump that draws lubricant from bulk tank 40. Level manager 16 generates the supply control signal based on the control signal from the control level sensor 44 and generates the alarm signal based on the monitor signal from the monitor level sensor 46.

High level sensor and low level sensor are mounted to bulk tank 40. High level sensor and low level sensor are operatively connected to level manager 16, such as by wired or wireless communication links. In the example discussed, the low level sensor is designated as the control level sensor 44 because in the first outflow substate the lubricant flow out of bulk tank 40 is actively controlled, which outflow causes dropping lubricant levels in bulk tank 40. For example, the low level sensor can be wired to the connector at connection points associated with the control level sensor 44 and the high level sensor can be wired to the connector at connection points associated with the monitor level sensor 46, thereby designating the low level sensor as the control level sensor 44 and designating the high level sensor as the monitor level sensor 46.

The level manager 16 identifies the low level sensor as the control level sensor 44 and identifies the high level sensor as the monitor level sensor 46. Level manager 16 is placed in the desired substate to cause generation of the alarm signal and activation of tank alarm 48 based on the monitor level sensor 46. For example, a control switch of the channel by which supply system 26 is connected can be actuated from a disabled state to a first dual state. With the control switch in the first dual state, the level manager 16 is configured to generate the alarm signal based on reception of the monitor signal from the monitor level sensor 46. Level manager 16 is thereby placed in the first outflow substate.

The control switch can be actuated to a second dual state (e.g., by twisting a knob, flipping one or switches, rotating a dial, etc.) in which level manager 16 is configured to generate the alarm signal based on reception of the control signal from the control level sensor 44. Placing the control switch in the second dual state places level manager 16 in the second outflow substate. To place level manager 16 in either of the inflow substates the low level sensor is connected to level sensor 16 as the monitor level sensor 46 and the high level sensor is connected to level sensor 16 as the control level sensor 44.

The control switch facilitates easy and quick configuration of each channel connected to level manager 16. The control switch can be placed in a disabled state. Placing control switch in the disabled state can close all connections of the channel. Closing all of the connections allows level manager 16 to operate in the closed state in which electrical contacts are normally closed without triggering false alarms or taking other undesired action. The control switch placing the channel in a closed, disabled state allows for quick configuration of any channels not in use. In prior systems, such connection points needed to be physically wired to closed states when not in use.

In some examples, level manager 16 can additionally or alternatively monitor electrical current levels on a per channel, per output device level. Level manager 16 can display and report an over-current event for each channel. For example, an incorrectly wired, or faulty solenoid can be indicated by level manager 16, such as by user interface 22. Level monitor 16 can monitor and de-activate the external voltage rail in the event of a short circuit. Level monitor 16 does not power down, instead level monitor 16 shuts off the external power and can display a notification via user interface 22, and level monitor 16 can transmit a signal indicating the applicable condition to system controller 14 in examples including system controller 14.

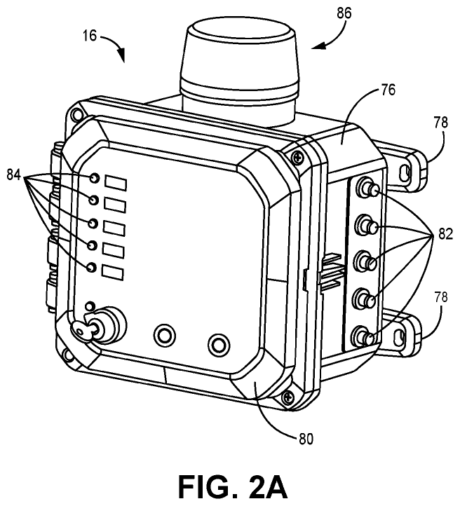

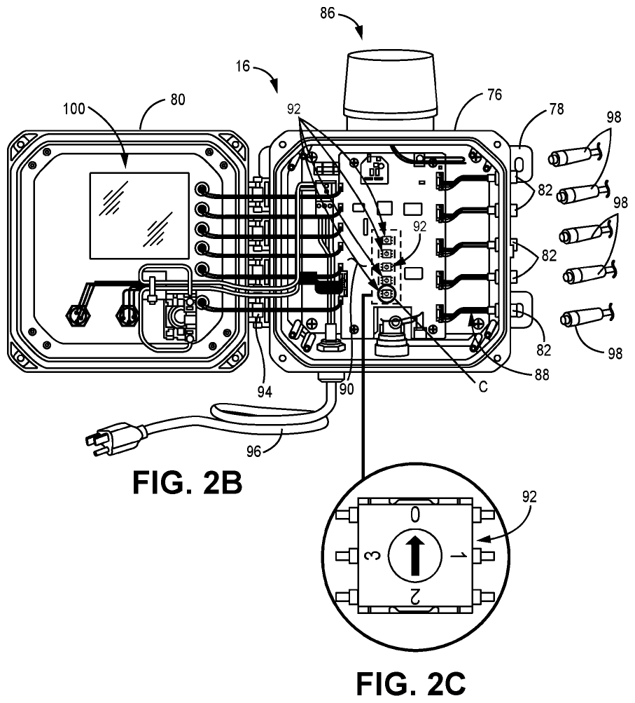

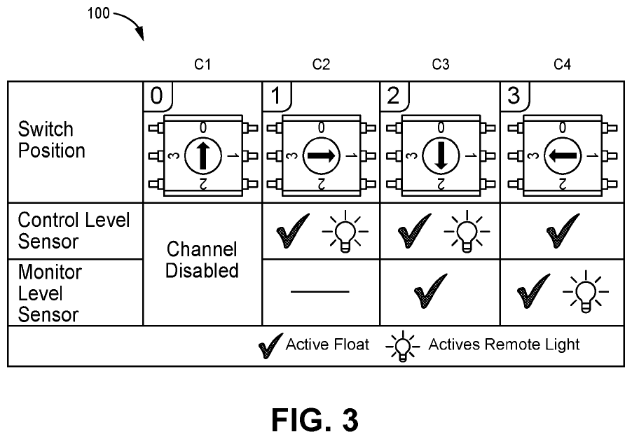

FIG. 2A is an isometric view of level manager 16. FIG. 2B is an elevational view of level manager 16 with door 80 opened to show an interior of level manager 16. FIG. 2C is an enlarged view of detail C in FIG. 2B showing a control switch 92. FIG. 3 is a diagram 100 illustrating operating states of the level manager 16 relative to positions of control switch 92.

Level manager 16 includes housing 76, feet 78, door 80, channel ports 82, status indicators 84, manager alarm 86, channel wiring 88, control board 90, control switches 92, indicator wires 94, and power cord 96.

Housing 76 contains other components of level manager 16. Level manager 16 is configured to be mounted within a facility. Feet 78 extend from housing 76. Feet 78 are disposed on a back side of housing 76 in the example shown. Level manager 16 is configured to mount to a vertical surface such as a vertical interior wall. Door 80 is connected to housing 76. Door 80 is configured to pivot on a hinge between a closed state, enclosing the interior of level manager 16, and an open state, exposing the interior of level manager 16.

Power cord 96 extends from housing 76. Power cord 96 is configured to provide electrical power to level manager 16 from a power source. The power cord 96 can connect to a wall outlet, such as a 120V wall outlet.

Status indicators 84 are exposed on the exterior of level manager 16. Status indicators 84 are exposed through door 80 in the example shown. Status indicators 84 form a portion of the user interface 22 of level manager 16 and are configured to provide a visual indication to a user. In the example shown, status indicators 84 are configured as light emitters configured to illuminate to provide an indication to the user. For example, a status indicator 84 can be illuminated based on level manager 16 receiving a level signal from a level sensor. The level manager 16 includes a status indicator 84 for each channel connectable to level manager 16. In the example shown, level manager 16 includes five status indicators 84 each associated with one of the five channels connectable to level manager 16. The status indicators 84 are individually associated with the channels such that each status indicator 84 is activated based only on signals from the associated channel. Status indicators 84 form discrete indicators that are individually associated with channels while manager alarm 86 is a general indicator that is associated with each channel.

Indicator wires 94 extend between control board 90 and status indicators 84. Indicator wires 94 are connected to status indicators 84 to provide activation signals to status indicators 84 to activate status indicators 84.

Manager alarm 86 is disposed on an exterior of housing 76. Manager alarm 86 forms a portion of user interface 22 and is configured to provide a visual indication to the user. The manager alarm 86 is configured as a rotating beacon in the example shown. The level manager 16 can be configured to activate manager alarm 86 based on receiving a level signal from any channel connected to level manager 16. In some examples, manager alarm 86 further includes an auditory output, such as a speaker, configured to generate an audible output detectable by a user.

Channel ports 82 form connection points for the connector 98 of each channel. The connector 98 can fix to the channel port 82 by a threaded interface. As discussed above, the components of the distribution system 10 can be wired to the connector 98 to designate the control level sensor 44 and the monitor level sensor 46. Each channel port 82 is configured to interface with only one channel.

Channel wiring 88 extends between channel ports 82 and control board 90. Control board 90 can be formed as a printed circuit board (PCB). Control board 90 can be configured to include control circuitry 18 and/or memory 20. Control board 90 is disposed within the interior of level manager 16.

Control switches 92 are mounted to control board 90. Control switches 92 are actuatable between various states. Control switches 92 can be considered to form portions of the user interface 22 of level manager 16. Placing the control switch 92 in the various positions configures level manager 16 to operate in a certain state for the channel associated with that control switch 92. In the example shown, a single control switch 92 is associated with each channel. The level manager 16 includes the same number of control switches 92 as channel ports 82. Each control switch 92 configures a single channel and does not affect operation of components on any other channel and does not affect generation or provision of signals on any other channel. Control switch 92 can be formed as a manual electric switch that is packaged with others in a group in a standard dual in-line package (DIP). Control switch 92 can be formed as a DIP switch. Control switch 92 can be formed as a rotary style DIP switch, among other options.

In the example shown, control switch 92 is actuatable between a disabled state, a single control state, a first dual control state, and a second dual control state. The various states and associated operational logic are illustrated in diagram 100 shown in FIG. 3. The disabled state, shown in column C1, is associated with no channel being connected to level manager 16. The control switch 92 being in the disabled state closes the channel connections such that level manager 16 can consider all connections of that channel to be closed.

The control switch 92 can be actuated to the single control state, shown in column C2. In the single sensor state, the level manager 16 considers the channel to include a single level sensor forming the control level sensor 44 and considers the channel to not include any monitor level sensor 46. For example, the channel for waste system 24 (FIG. 1) can be placed in the single control state as waste system 24 includes a single level sensor (the waste level sensor 36).

The control switch 92 can be actuated to the first dual control state, shown in column C4. With the control switch 92 in the first dual sensor state, the level manager 16 is configured to receive the control signal from the control level sensor 44 and is configured to receive the monitor signal from the monitor level sensor 46. In the first dual control state, the level manager 16 is configured to generate the alarm signal based on the monitor signal from the monitor level sensor 46.

The control switch 92 can be actuated to the second dual control state, shown in column C3. With control switch 92 in the second dual sensor state, the level manager 16 is configured to receive the control signal from the control level sensor 44 and is configured to receive the monitor signal from the monitor level sensor 46. In the second dual control state, the level manager 16 is configured to generate the alarm signal based on the control signal from the control level sensor 44.

Level manager 16 provides significant advantages. Level manager 16 is configured to connect with multiple level sensors via a single channel. The level sensors are designated as control level sensor 44 and monitor level sensor 46 and such designation affects the commands output by level manager 16. Level manager 16 is easily configurable between various substates, including taking a channel offline when not in use. The control switches 92 facilitates simple configuration of each channel of level manager 16.

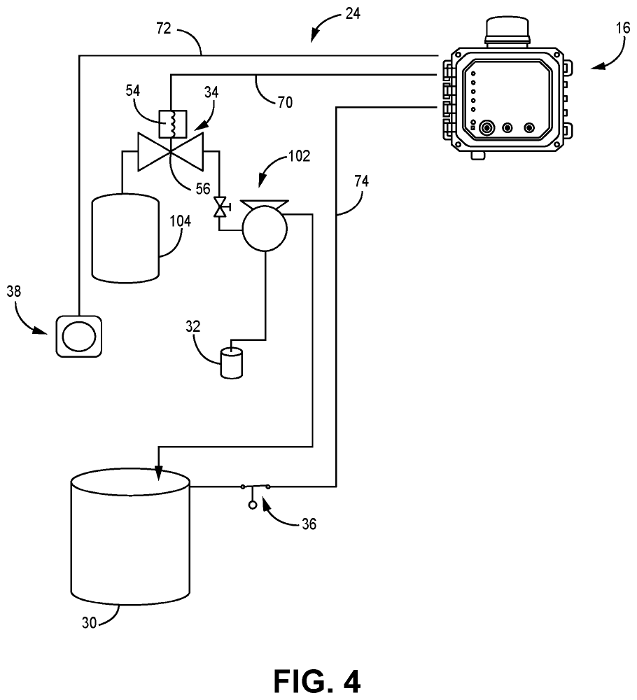

FIG. 4 is a schematic diagram showing level manager 16 connected to waste system 24. Waste tank 30, collection vessel 32, waste flow control 34, waste level sensor 36, waste tank alarm 38, waste pump 102, and air supply 104 are shown. Waste pump 102 is configured as a pneumatic pump powered by compressed air from air supply 104. Waste pump 102 can be of any type suitable for pumping waste lubricant to waste tank 30, such an air operated double diaphragm pump, among other options. Air supply 104 can be of any suitable configuration for providing compressed air for powering waste pump 102, such as one or more tanks, an air compressor, etc.

During operation, level manager 16 is configured to generate and send a waste control signal to waste flow control 34 based on the level manager 16 receiving the waste level signal from waste level sensor 36. It is understood that the waste level sensor 36 can be considered to be a control level sensor for the waste system 24. The level manager 16 can be placed in a single control state for monitoring and operation of waste system 24, such as by manipulation of a control switch 92 associated with the channel by which waste system 24 is connected to level manager 16.

The waste control signal causes waste flow control 34 to actuate to an off state to stop flow compressed gas from air supply 104 to pump 102, thereby stopping flow of waste lubricant to waste tank 30. The level manager 16 can further generate and send a waste signal to waste tank alarm 38 to cause activation of waste tank alarm 38. The level manager 16 can further activate the manager alarm 86 in response to the waste level signal.

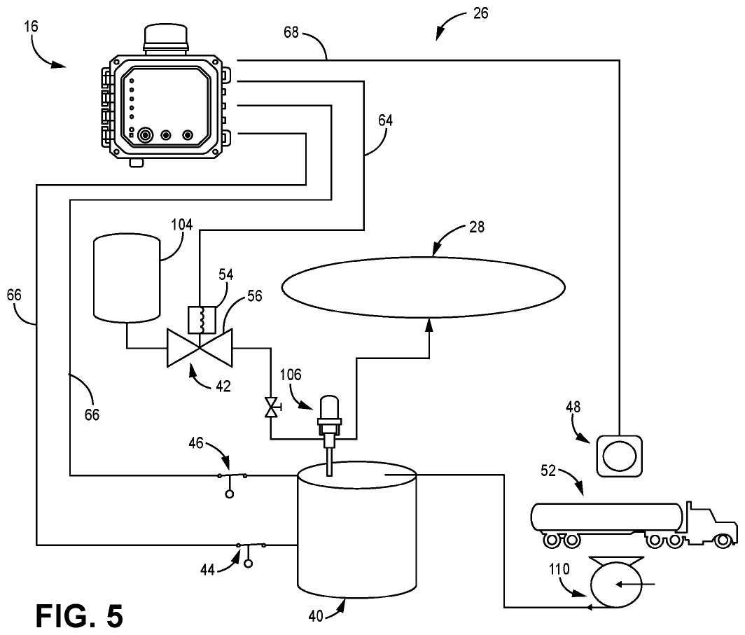

FIG. 5 is a schematic diagram showing level manager 16 connected to supply system 26. Level manager 16 is configured to operate in an outflow state in the example shown in FIG. 5. As discussed above, level manager 16 can be actuated between the first output substate and the second outflow substate by manipulation of a control switch 92 associated with the channel by which supply system 26 is connected to level manager 16.

Level manager 16 is configured to send the supply control signal to supply flow control 42 to stop operation of supply pump 106 based on level manager 16 receiving the low level signal from the control level sensor 44. Supply pump 106 is configured to pump lubricant from bulk tank 40 to application system 28. Supply pump 106 can be of any type suitable for pumping the lubricant, such as a diaphragm pump, piston pump, peristaltic pump, plunger pump, etc. Supply pump 106 is configured as a pneumatic pump powered by compressed air from air supply 104 in the example shown. Air supply 104 can be of any suitable configuration for providing compressed air for powering supply pump 106, such as one or more tanks, an air compressor, etc.

The low level sensor is designated as the control level sensor 44 with level manager 16 in the outflow state. The high level sensor is designated as the monitor level sensor 46 with level manager in the outflow state. The level manager 16 is configured to generate the alarm signal and activate tank alarm 48 based on the monitor signal from the monitor level sensor 46 with level monitor 16 in the first outflow substate. In the first outflow substate, tank alarm 48 is disposed proximate fill pump 110 that drives lubricant to fill bulk tank 40. Fill pump 110 can be of any type suitable for pumping fresh lubricant to fill bulk tank 40. For example, fill pump 110 can be powered by a powered take off (PTO), hydraulically powered, etc. Fill pump 110 can be part of the vehicle forming supply vessel 52 such that fill pump 110 is not normally part of distribution system 10. The level manager 16 is configured to generate the alarm signal and activate tank alarm 48 based on the control signal from the control level sensor 46 with level monitor 16 in the second outflow substate.

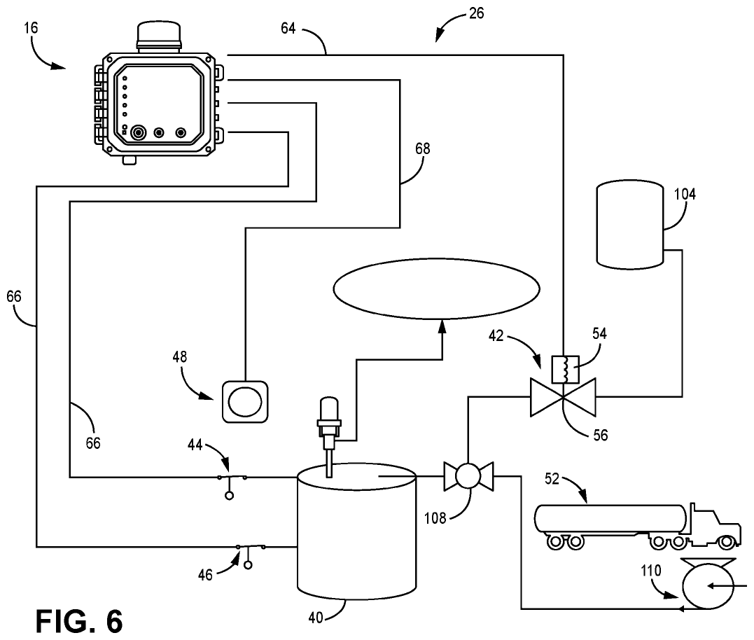

FIG. 6 is a schematic diagram showing level manager 16 connected to supply system 26. Level manager 16 is configured to operate in the inflow substate in the example shown in FIG. 6. As discussed above, level manager 16 can be actuated between the first inflow substate and the second inflow substate by manipulation of a control switch 92 associated with the channel by which supply system 26 is connected to level manager 16.

Level manager 16 is configured to send the supply control signal to supply flow control 42 to cause fill valve 108 to actuate to a closed state to stop flow of lubricant to bulk tank 40. Fill valve 108 is actuatable between an open state, in which lubricant can flow to bulk tank 40, and a closed state, in which lubricant cannot flow to bulk tank 40. Fill valve 108 can be configured as an actively controlled ball valve, among other options. Fill valve 108 can be normally closed such that powering fill valve 108 actuates fill valve 108 to the open state. The level manager 16 is configured to close fill valve 108 based on level manager 16 receiving the high level signal from the control level sensor 44. The high level sensor is designated as the control level sensor 44 with level monitor 16 in the inflow state. The low level sensor is designated as the monitor level sensor 46 with level monitor 16 in the inflow state. The level manager 16 is configured to generate the alarm signal and activate tank alarm 48 based on the monitor signal from the monitor level sensor 46 with level monitor 16 in the second inflow substate. In the second inflow substate, tank alarm 48 is disposed to alert a user that the lubricant level in the bulk tank 40 has reached the lower level threshold. The level manager 16 is configured to generate the alarm signal and activate tank alarm 48 based on the control signal from the control level sensor 46 with level monitor 16 in the first inflow substate.

FIG. 7 is a schematic diagram showing an alternative level manager 16′ connected to supply system 26. Level manager 16′ is configured such that each channel can include up to twelve connection points that support controlling operation of up to six components. For example, the connector 98 can be configured to include up to twelve discrete connection points. In the example shown, the high level sensor forms a first control level sensor 44a and the low level sensor forms a second control level sensor 44b. Supply system 26 includes an output flow control 42a and an input flow control 42b. The output flow control 42a and input flow control 42b are configured as supply flow controls 42 of the supply system 26. The output flow control 42b is operatively associated with supply pump 106 to control operation of supply pump 106. The input flow control 42a is operatively associated with fill valve 108 and is configured to control operation of fill valve 108. Supply system 26 further includes tank alarm 48a and tank alarm 48b.

Level manager 16′ is operatively connected to tank alarm 48a by alarm line 68a. Level manager 16′ is operatively connected to tank alarm 48b by alarm line 68b. Level manager 16′ is operatively connected to control level sensors 44a, 44b by sensor lines 66. Level manager 16′ is operatively connected to output flow control 42a by control line 64a. Level manager 16′ is operatively connected to input flow control 42b by control line 64b.

The level manager 16′ can be configured to control operation of supply pump 106 based on the low level signal from the control level sensor 44b and can be configured to activate one of tank alarms 48, such as tank alarm 48b, based on the low level signal from control level sensor 44b. The level manager 16′ can activate output flow control 42b to cause deactivation of pump 106 based on the low level signal from control level sensor 44b. The level manager 16′ can be configured to control operation of fill valve 108 based on the high level signal from the control level sensor 44a and can be configured to activate the other one of tank alarms 48, such as tank alarm 48a, based on the high level signal from control level sensor 44a. The level manager 16′ can activate output flow control 42a to cause closure of fill valve 108 based on the high level signal from control level sensor 44a. The six components connected to level manager 16 on the single channel can be the supply flow control 42b of the supply pump 106, the supply flow control 42a of the fill valve 108, the high level sensor forming control level sensor 44a, the low level sensor forming control level sensor 44b, and the two tank alarms 48a, 48b.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A level manager for a lubricant distribution system, the level manager comprising:
a housing;
a plurality of channel ports mounted to the housing, each channel port providing a connection point for data and power communications with the level manager;
control circuitry; and
memory encoded with instructions that, when executed by the control circuitry, cause the control circuitry to:
generate a control signal in response to a control level signal from a control level sensor and provide the control signal to a flow control, the flow control configured to stop flow of lubricant one of into a lubricant tank and out of the lubricant tank based on the control signal; and
generate an alarm signal in response to one of the control level signal and a monitor level signal from a monitor level sensor and provide the alarm signal to a tank alarm to activate the tank alarm;
wherein the control level sensor is one of a high level sensor of the lubricant tank and a low level sensor of the lubricant tank, and wherein the monitor level sensor is the other one of the high level sensor and the low level sensor; and
wherein the control level sensor, the monitor level sensor, the flow control, and the tank alarm are connected to the level manager via a signal channel connected to a single channel port of the plurality of channel ports.

2. The level manager of claim 1, wherein the level manager is operable in an outflow state in which the low level sensor forms the control level sensor such that the control level signal is generated based on fall of the lubricant within the lubricant tank, and wherein the flow control is configured to stop flow of the lubricant out of the lubricant tank.

3. The level manager of claim 2, wherein the level manager is operable is a first outflow substate in which the tank alarm signal is generated based on the monitor level signal such that the tank alarm is activated based on rise of the lubricant within the lubricant tank.

4. The level manager of claim 2, wherein the level manager is operable in a second outflow substate in which the tank alarm signal is generated based on the control level signal such that the tank alarm is activated based on fall of the lubricant within the lubricant tank.

5. The level manager of claim 1, wherein the level manager is operable in an inflow state in which the high level sensor forms the control level sensor such that the control level signal is generated based on rise of the lubricant within the lubricant tank, and wherein the flow control is configured to stop flow of the lubricant into the lubricant tank.

6. The level manager of claim 5, wherein the level manager is operable is a first inflow substate in which the tank alarm signal is generated based on the control level signal such that the tank alarm is activated based on rise of the lubricant within the lubricant tank.

7. The level manager of claim 1, wherein the level manager is operable in a second inflow substate in which the tank alarm signal is generated based on the monitor level signal such that the tank alarm is activated based on fall of the lubricant within the lubricant tank.

8. The level manager of claim 1, further comprising:
a plurality of control switches, wherein each control switch of the plurality of control switches is operatively associated with one channel of the level manager, and wherein each control switch of the plurality of control switches is configured to set an operational state of the one channel.

9. The level manager of claim 1, further comprising a control switch operatively associated with the single channel, wherein the control switch is configured to set an operational state of the single channel, the operational state is configured as one of:
a first outflow substate in which the low level sensor forms the control level sensor, the high level sensor forms the monitor sensor, and the level monitor is configured to generate the alarm signal based on the monitor level signal;
a second outflow substate in which the low level sensor forms the control level sensor, the high level sensor forms the monitor sensor, and the level monitor is configured to generate the alarm signal based on the control level signal;
a first inflow substate in which the high level sensor forms the control level sensor, the low level sensor forms the monitor sensor, and the level monitor is configured to generate the alarm signal based on the control level signal; and
a second inflow substate in which the high level sensor forms the control level sensor, the low level sensor forms the monitor sensor, and the level monitor is configured to generate the alarm signal based on the monitor level signal.

10. The level manager of claim 9, wherein the control switch is manually manipulable between a plurality of switch positions associated with different ones of the operational states.

11. The level manager of claim 10, wherein the control switch is a rotary switch.

12. The level manager of claim 10, wherein the control switch is a DIP switch.

13. The level manager of claim 1, wherein the level manager is configured to identify the control level sensor based on a wired connection interface between the level manager and a first one of the high level sensor and the low level sensor, and wherein the level manger is configured to identify the monitor level sensor based on a wired connection interface between the level manger and a second one of the high level sensor and the low level sensor.

14. The level manager of claim 1, wherein the flow control includes a solenoid and a valve, the solenoid configured to actuate the valve to a closed state.

15. The level manager of claim 14, wherein the valve is an air valve configured to block a flow of compressed air to one of a pump to stop operation of the pump and a fill valve to cause the fill valve to shift to a closed state.

16. The level manager of claim 1, wherein the high level sensor is a float sensor in which a float is configured to actuate a switch to open a contact to generate a high level signal.

17. The level manger of claim 1, wherein the low level sensor is a float sensor in which a float is configured to actuate a switch to open a contact to generate a low level signal.

18. A fluid management system comprising:
the level manager of claim 1; and
a system controller;
wherein the level manager is configured to generate a tank status signal and send the tank status signal to the system controller, the system controller configured to generate and send an electronic communication outside of the lubricant distribution system based on the tank status signal.

19. (canceled)

20. (canceled)

21. A level manager for use in a lubricant distribution system, the level manager comprising:
a housing;
a plurality of channel ports mounted to the housing, each channel port providing a connection point for a channel to connect with the level manager;
a plurality of control switches, each control switch operably associated with a single channel of the plurality of channels;
control circuitry; and
memory encoded with instructions that, when executed by the control circuitry, cause the control circuitry to:
generate a control signal in response to a control level signal from a control level sensor and provide the control signal to a flow control, the flow control configured to stop flow of lubricant one of into a lubricant tank and out of the lubricant tank based on the control signal; and
generate an alarm signal in response to one of the control level signal and a monitor level signal from a monitor level sensor and provide the alarm signal to a tank alarm to activate the tank alarm;
wherein each control switch is actuatable between a plurality of positions that are each associated with different operational states of the level manager for the single channel, the operational states including:
a first substate in which the level manager is configured to generate the alarm signal based on the control signal; and
a second substate in which the level manager is configured to generate the alarm signal based on the monitor signal.

22. (canceled)

23. (canceled)

24. A lubricant distribution system comprising:
a bulk tank configured to store a supply of fresh lubricant;
a pump configured to pump the fresh lubricant from the bulk tank to an application system;
a flow control configured to disable pumping by the pump based on receipt of a flow control signal;
a tank alarm configured to output a visual alarm, an audio alarm, or both based on receipt of an alarm signal;
a low level sensor configured to generate a control level signal based on fall of lubricant within the bulk tank;
a high level sensor configured to generate a monitor level signal based on rise of lubricant within the bulk tank; and
a level manager configured to:
generate the flow control signal in response to the control level signal from the low level sensor; and
generate the alarm signal in response to one of the control level signal and the monitor level signal;
wherein the level manager is operable in a first substate in which the level manager generates the alarm signal based on the control level signal and in a second substate in which the level manager generates the alarm signal based on the monitor level signal.

25. (canceled)

26. (canceled)
